(19) United States
(12) Patent Application Publication
(10) Pub. No.: US 2026/0194709 A1
(43) Pub. Date: Jul. 9, 2026

(54) PHASE CONTROL WAVEGUIDE STRUCTURE BASED ON ANISOTROPIC MATERIAL AND WAVELENGTH DIVISION MULTIPLEXER STRUCTURE THEREOF

(71) Applicants: JIAXING RESEARCH INSTITUTE, ZHEJIANG UNIVERSITY, Jiaxing (CN); ZHEJIANG UNIVERSITY, Hangzhou (CN)

(72) Inventors: Liu Liu, Hangzhou (CN); Junjie Yi, Hangzhou (CN); Xiaowei Guan, Jiaxing (CN); Zhaoyang Chen, Jiaxing (CN); Guowu Zhang, Jiaxing (CN)

(21) Appl. No.: 19/560,262

(22) Filed: Mar. 9, 2026

Related U.S. Application Data
(63) Continuation of application No. PCT/CN2023/128891, filed on Oct. 31, 2023.

(30) Foreign Application Priority Data
Sep. 8, 2023 (CN) 202311158928.8

(51) Int. Cl. G02B 6/12; G02B 6/125; G02F 1/21

(52) U.S. Cl. CPC G02B 6/12011; G02B 6/125; G02F 1/212; G02B 2006/1204; G02F 2202/20

(57) ABSTRACT

A phase control waveguide structure based on an anisotropic material and a wavelength division multiplexer structure thereof are provided. A phase control waveguide, as part of a wavelength division multiplexer, is symmetrically designed along a special angle. Based on this method, an arrayed waveguide grating for implementing a wavelength division multiplexer on the anisotropic material, and a cascaded Mach-Zehnder interferometer structure are further provided.

### CROSS REFERENCE TO RELATED APPLICATIONS

The present application is a Continuation application of PCT Application No. PCT/CN2023/128891 filed on Oct. 31, 2023, which claims the benefit of Chinese Patent Application No. 202311158928.8 filed on Sep. 8, 2023. All the above are hereby incorporated by reference in their entirety.

### TECHNICAL FIELD

The disclosure relates to the field of photonic integration devices, in particular, to a phase control waveguide structure based on an anisotropic material and a wavelength division multiplexer structure thereof.

### BACKGROUND

In recent years, global communication data traffic has increased exponentially, and therefore, communications technologies have been improved unprecedentedly. An optical communication technology has become the most important transmission mode in modern communication due to advantages such as a large communication capacity, a strong interference immunity, and low construction costs. In an optical communication system, compared with other multiplexing technologies, a wavelength division multiplexing (WDM) technology can greatly expand a communication bandwidth by simultaneously transmitting multiple paths of independent signals in a same optical fiber.

An arrayed waveguide grating (AWG) is one of main devices for implementing on-chip wavelength division multiplexing technologies, and has comprehensive advantages such as strong stability, high resolution, and a large number of channels. Main structures thereof include an input end free propagation region, an arrayed waveguide, and an output end free propagation region.

A cascaded Mach-Zehnder Interferometer (MZI) is also one of main devices for implementing wavelength division multiplexing technologies, and has advantages such as simple manufacturing, small chip occupation, and low insertion loss compared with the arrayed waveguide grating. Main structures thereof include an input waveguide, a 3 dB directional coupler, a phase control waveguide, and an output waveguide.

As an emerging photonic integration chip material, thin film lithium niobate (TFLN) not only has advantages of a low loss and a wide transmission spectrum, but also has an excellent electro-optical effect, relatively large nonlinear optical coefficients, and stable chemical properties. In addition, compared with a conventional bulk lithium niobate material, the thin film lithium niobate can significantly reduce a device size due to a higher refractive index contrast of the thin film lithium niobate to the surroundings (usually air or silica).

Thin film lithium niobate wafers may be classified into X-cut, Y-cut, and Z-cut. X-cut and Z-cut are the most common. To make use of a maximum electro-optical coefficient γ₃₃ of a lithium niobate crystal, a waveguide transmission mode on an X-cut wafer is selected to be a transverse electric (TE) mode, and a waveguide transmission mode on a Z-cut wafer is selected to be a transverse magnetic (TM) mode. Compared with the TM mode, the TE mode has a higher overlap integral with an electric field, and therefore, the X-cut lithium niobate thin film has better electro-optical properties.

When an arrayed waveguide grating is designed, a constant optical path difference needs to be ensured between arrayed waveguide paths, and inevitably, there are bent waveguides of different angles and straight waveguides of different directions. However, on the X-cut thin film lithium niobate, the refractive index is related to a waveguide direction, causing an increase in design difficulty and a relatively high requirement for a device manufacturing process. Currently, the design of an arrayed waveguide grating on the X-cut thin film lithium niobate has not been implemented in the world.

When a cascaded MZI is designed, each single-level MZI needs to ensure that an optical path difference between upper and lower arms is a particular value. Similarly, on the X-cut thin film lithium niobate, the design of the phase control waveguide also needs to consider changes of the waveguide refractive index in different directions. Currently, a relatively common design is to adopt a special structural design so that bent waveguide structures of upper and lower arms cancel each other, and an optical path difference is determined only by a length difference and a refractive index difference of a straight waveguide. A cascaded MZI designed in this method usually has a relatively large size.

### SUMMARY

An objective of the disclosure is to provide a phase control waveguide structure based on an anisotropic material and a wavelength division multiplexer structure thereof. The main idea of the phase control waveguide structure is to symmetrically design a phase control waveguide part of a wavelength division multiplexer along a special angle, so as to avoid the difficulty in designing the wavelength division multiplexer and the negative impact on accurate phase control of the wavelength division multiplexer caused by a birefringence effect of the anisotropic material. Especially, the focus is on the wavelength division multiplexer based on the anisotropic material.

A technical solution for achieving the objective of the disclosure is to arrange the phase control waveguide part in the wavelength division multiplexer along an axis that forms an included angle of 45° or 135° with both crystal axes of the surface of the anisotropic material. This is specifically represented as follows: in the arrayed waveguide grating, structures such as an input free propagation region, an arrayed waveguide, and an output free propagation region are symmetrical about the 45° or 135° axis. In the cascaded MZI, each single-level MZI part is symmetrical about the 45° or 135° axis.

The disclosure is implemented by the following technical solutions:

The disclosure provides a phase control waveguide structure. The phase control waveguide structure includes two-side waveguide units that are symmetrically arranged. The waveguide unit includes a straight waveguide and a bent waveguide that are connected. The phase control waveguide structure includes a straight waveguide A, a bent waveguide A, a bent waveguide B, and a straight waveguide B that are sequentially connected. The straight waveguide A, the bent waveguide A, the bent waveguide B, and the straight waveguide B are symmetrically arranged along an axis that forms an included angle of 45° or 135° with both crystal axes of a surface of an anisotropic material.

As a further improvement, in the disclosure, a length of the straight waveguide A is equal to that of the straight waveguide B, and a bending radius and a bending angle of the bent waveguide A are equal to those of the bent waveguide B.

As a further improvement, in the disclosure, a cross section of the phase control waveguide structure includes a buried oxide layer, a waveguide layer, and a silicon dioxide upper clad layer from bottom to top, and the anisotropic material is X-cut thin film lithium niobate.

As a further improvement, in the disclosure, a radius of the bent waveguide is equal to or greater than 50 microns, and the waveguide layer is a ridge waveguide or a strip waveguide.

The disclosure further provides a wavelength division multiplexer structure based on an arrayed waveguide grating, based on an anisotropic material and including a phase control waveguide structure. The structure includes an input waveguide, an input end free propagation region, an input end tapered waveguide, an arrayed waveguide, an output end tapered waveguide, an output end free propagation region, and an output waveguide that are sequentially connected.

As a further improvement, in the disclosure, the input end free propagation region and the output end free propagation region, the input end tapered waveguide and the output end tapered waveguide, and the arrayed waveguide itself are symmetrically arranged about an axis that forms an included angle of 45° or 135° with both crystal axes of a surface of the anisotropic material.

As a further improvement, in the disclosure, the input end tapered waveguide and the output end tapered waveguide are configured to reduce a coupling loss between modes, and the input waveguide and the output waveguide are respectively configured for input and output of optical signals.

The disclosure further provides a wavelength division multiplexer structure based on a cascaded Mach-Zehnder interferometer, based on an anisotropic material and including a phase control waveguide structure. The structure is a binary tree structure including single-level MZI units connected by a 3 dB directional coupler. The single-level MZI unit includes an upper arm and a lower arm of the phase control waveguide structure, and the upper arm and the lower arm are symmetrically arranged about an axis that forms an included angle of 45° or 135° with both crystal axes of a surface of the anisotropic material.

As a further improvement, in the disclosure, the structure includes an input waveguide, single-level MZI units, a 3 dB directional coupler connected to each single-level MZI unit and configured for beam combining and beam splitting, and an output waveguide.

As a further improvement, in the disclosure, each single-level MZI unit includes two interference arms, that is, an upper arm and a lower arm, formed after beam splitting, and the upper arm and the lower arm have a length difference.

Compared with the related art, the disclosure has the following beneficial effects:

1) A wavelength division multiplexer based on an arrayed waveguide grating structure is designed on an anisotropic material, so as to overcome the difficulty caused by the birefringence effect to accurate phase control.

2) A method for designing a cascaded MZI on an anisotropic material is optimized, so that a phase control waveguide is more efficient and compact.

3) In the disclosure, a wavelength division multiplexer is designed by taking an anisotropic material, that is, X-cut thin film lithium niobate as an example. Compared with a conventional material, that is, silicon, the wavelength division multiplexer has advantages such as a wide transmission spectrum and a low loss, has excellent nonlinear characteristics and electro-optical characteristics, and has a potential of implementing richer functions.

### BRIEF DESCRIPTION OF THE DRAWINGS

FIG. 1 is a schematic view of design method principle and phase control waveguide arrangement;

1 is a straight waveguide A, 2 is a bent waveguide A, 3 is a bent waveguide B, 4 is a straight waveguide B, and the structure is symmetrical about an axis that forms an included angle of 45° or 135° with both Y and Z crystal axes;

FIG. 2 is a schematic top view of a wavelength division multiplexer based on an arrayed waveguide grating structure on an anisotropic material according to the disclosure;

5 is an input waveguide, 6 is an input end free propagation region, 7 is an input end tapered waveguide, 8 is an arrayed waveguide, 9 is an output end tapered waveguide, 10 is an output end free propagation region, and 11 is an output waveguide, where when the anisotropic material is X-cut thin film lithium niobate, a Z direction is a Z crystal axis direction thereof;

FIG. 3 is a top view of a wavelength division multiplexer based on a cascaded MZI structure on an anisotropic material according to the disclosure;

12 is an upper arm, 13 is a lower arm, 14 is an input waveguide, 15 is a 3 dB directional coupler, and 16 is an output waveguide, where when the anisotropic material is X-cut thin film lithium niobate, a Z direction is a Z crystal axis direction thereof;

FIG. 4 is a schematic view of a cross-sectional structure of a waveguide when an anisotropic material is X-cut thin film lithium niobate according to the disclosure; and

17 is a silicon dioxide upper clad layer, 18 is a waveguide layer, and 19 is a buried oxide layer, where an X direction is an X crystal axis direction of the thin film lithium niobate.

### DETAILED DESCRIPTION

The disclosure provides a phase control waveguide structure and a wavelength division multiplexer structure thereof, and relates to a design method and structure for implementing a wavelength division multiplexer on an anisotropic material, including a phase control waveguide structure, a wavelength division multiplexer structure based on an arrayed waveguide grating, and a wavelength division multiplexer structure based on a cascaded Mach-Zehnder interferometer, and an anisotropic material, that is, X-cut thin film lithium niobate is taken as an example for specific description. The anisotropic material may also be a barium titanate material.

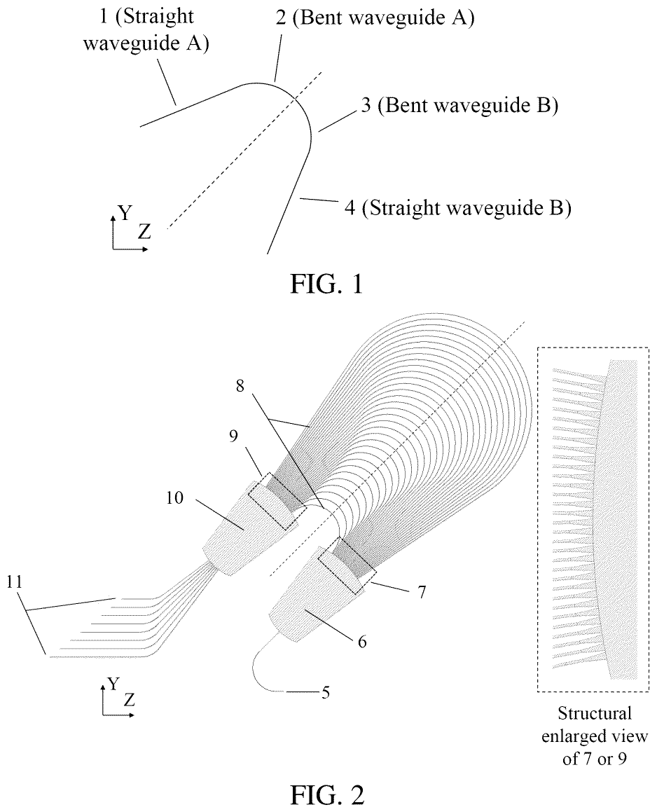

FIG. 1 is a schematic view of a path of a phase control waveguide part according to the disclosure. The phase control waveguide structure includes two-side waveguide units that are symmetrically arranged. The waveguide unit includes a straight waveguide and a bent waveguide that are connected. The two-side waveguide units include a straight waveguide A1, a straight waveguide B4, a bent waveguide A2, and a bent waveguide B3. The four waveguides are sequentially connected. The structure is symmetrical about an axis that forms an included angle of 45° with both a Y crystal axis and a Z crystal axis. That is, a length of the straight waveguide A1 is equal to that of the straight waveguide B4, and a bending radius and a bending angle of the bent waveguide A2 are also equal to those of the bent waveguide B3. The straight waveguide A1, the bent waveguide A2, the bent waveguide B3, and the straight waveguide B4 are symmetrically arranged along an axis that forms an included angle of 45° or 135° with both crystal axes of the surface of the anisotropic material. The length of the straight waveguide A1 is equal to that of the straight waveguide B4, and the bending radius and the bending angle of the bent waveguide A2 are equal to those of the bent waveguide B3.

FIG. 2 is a top view of a wavelength division multiplexer based on an arrayed waveguide grating structure and based on X-cut thin film lithium niobate, and is a wavelength division multiplexer structure based on an arrayed waveguide grating and including a phase control waveguide structure. An arrayed waveguide path is the same as that in FIG. 1, and also includes straight waveguides and bent waveguides. The structure includes an input waveguide 5, an input end free propagation region 6, an input end tapered waveguide 7, an arrayed waveguide 8, an output end tapered waveguide 9, an output end free propagation region 10, and an output waveguide 11 that are sequentially connected. The input end free propagation region 6 itself, the output end free propagation region 10 itself, the input end tapered waveguide 7 and the output end tapered waveguide 9, and the arrayed waveguide 8 itself are symmetrical about an axis that forms an included angle of 45° with both a Y crystal axis and a Z crystal axis. The input end tapered waveguide 7 and the output end tapered waveguide 9 are configured to reduce a coupling loss between modes. The input waveguide 5 and the output waveguide 11 are respectively configured for input and output of optical signals.

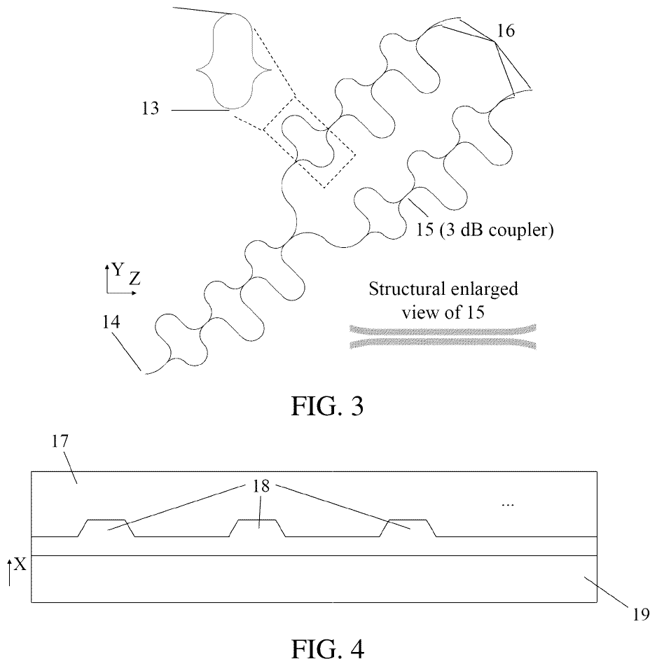

FIG. 3 is a top view of a wavelength division multiplexer based on a cascaded MZI structure, based on X-cut thin film lithium niobate, and is a wavelength division multiplexer structure based on a cascaded Mach-Zehnder interferometer and including a phase control waveguide structure, where a phase control waveguide path is the same as that in FIG. 1, and also includes straight waveguides and bent waveguides. The structure is a binary tree structure including single-level MZI units connected by a 3 dB directional coupler 15. The single-level MZI unit includes an upper arm 12 and a lower arm 13 of the phase control waveguide structure, and the upper arm 12 and the lower arm 13 are symmetrically arranged about an axis that forms an included angle of 45° or 135° with both crystal axes of the surface of the anisotropic material.

The phase control waveguide structure of each level of MZI is symmetrical about an axis that forms an included angle of 135° with both the Y crystal axis and the Z crystal axis, and the upper arm 12 of the single-level MZI and the lower arm 13 of the single-level MZI are configured to generate an optical path difference. The 3 dB directional coupler 15 is configured for beam splitting and beam combining of the MZI. The input waveguide 14 and the output waveguide 16 are respectively configured for input and output of optical signals.

The structure includes an input waveguide 14, single-level MZI units, a 3 dB directional coupler 15 connected to each single-level MZI unit and configured for beam combining and beam splitting, and an output waveguide 16. Each single-level MZI unit includes two interference arms, that is, an upper arm 12 and a lower arm 13, formed after beam splitting, and the upper arm 12 and the lower arm 13 have a length difference.

As shown in FIG. 4, a cross section of the phase control waveguide structure includes a buried oxide layer 19, a waveguide layer 18, and a silicon dioxide upper clad layer 17 from bottom to top, and the anisotropic material is X-cut thin film lithium niobate. A radius of the bent waveguide is equal to or greater than 50 microns, and the waveguide layer is a ridge waveguide or a strip waveguide. In the arrayed waveguide grating and the cascaded MZI, the refractive index of the waveguide layer 18 is greater than the refractive index of the silicon dioxide upper clad layer 17 and the refractive index of the buried oxide layer 19, and an optical field is limited in the waveguide layer 19 and is stably transmitted.

To reduce a bending loss and avoid mode mixing, a bending radius of the bent waveguide in FIG. 2 and FIG. 3 is not less than 50 microns.

The cross-sectional structure of the thin film lithium niobate waveguide in FIG. 4 is a ridge waveguide or a strip waveguide.

When the arrayed waveguide 8 is used, multi-wavelength optical signals enter the input end free propagation region 6 through the input waveguide 5 from an optical fiber and then undergo diffraction, and the light energy is in Gaussian distribution and enters the input end tapered waveguide 7 at an inlet of each arrayed waveguide 8. The arrayed waveguide 8 is designed to ensure that an optical path difference between adjacent waveguides is constant. When multiple paths of optical signals outputted by the arrayed waveguide 8 enter the output end free propagation region 10, because of different phase differences, optical signals of different wavelengths are interfered and superposed in the output end free propagation region 10, then are focused on different positions and are exported by the output waveguide 11, thereby implementing beam splitting of different wavelengths.

When the cascaded MZI is used, multi-wavelength optical signals are inputted through the input waveguide 14 from an optical fiber and pass through the 3 dB directional coupler 15, and then, the light is divided into two beams of coherent light of equal intensity. The two beams of light are transmitted in two interference arms of the MZI. Because the lengths of the upper arm 12 and the lower arm 13 are different in the single-level MZI, a particular optical path difference is generated. Superposition interference is performed in the 3 dB directional coupler 15, and the light of a particular wavelength is enhanced by interference at a corresponding port and is outputted by different output waveguides 16, thereby implementing beam splitting of different wavelengths. In addition, a filter curve can be optimized by cascading a plurality of MZI structures, and the binary tree structure can multiplex light of more wavelengths.

To make the objectives, technical solutions, and advantages of the disclosure clearer and more comprehensible, the disclosure is further described in detail below with reference to the accompanying drawings and embodiments. The specific embodiments described herein are merely configured for explaining the disclosure, but are not intended to limit the disclosure. A design method and a wavelength division multiplexer structure are described in this specification, and an X-cut thin film lithium niobate material is taken as an example.

### Embodiment 1

This embodiment of the disclosure provides a design of a wavelength division multiplexer structure based on a novel arrayed waveguide grating of X-cut thin film lithium niobate. As shown in FIG. 2 and FIG. 4, the device sequentially includes an input waveguide 5, an input end free propagation region 6, an input end tapered waveguide 7 at an inlet of an arrayed waveguide, an arrayed waveguide 8, an output end tapered waveguide 9, an output end free propagation region 10, and an output waveguide 11 in FIG. 2. A cross section of the foregoing waveguide structure is shown in FIG. 4, and includes a thin film lithium niobate waveguide layer 19, a silicon dioxide upper clad layer 17, and a buried oxide layer 19.

To make light of different wavelengths form interference superposition at corresponding output waveguides, an equal phase difference needs to be generated between adjacent arrayed waveguides by means of design.

The X-cut lithium niobate thin film material has a birefringence effect, and an effective refractive index and a group refractive index of a waveguide are both related to a waveguide direction (related to an included angle with a Z crystal axis). The arrayed waveguides include straight waveguides, bent waveguides, and tapered waveguides in all directions. Therefore, it has a relatively large design difficulty in ensuring an equal phase difference between adjacent arrayed waveguides.

According to a simulation result of finite element simulation software, effective refractive indexes and group refractive indexes of a straight waveguide, a tapered waveguide, and a slab waveguide based on the X-cut thin film lithium niobate satisfy a relational expression (where θ is an included angle between a waveguide direction and a Z crystal axis):

$$n = {n}_{x} {cos}^{2} θ + {n}_{y} {sin}^{2} θ$$

Based on this relational expression, in this embodiment of the disclosure, the phase control waveguide part is designed by using an axis of 45° or 135° as an axis of symmetry. The following explains the principle of FIG. 1 as an example: a straight waveguide A1 and a straight waveguide B4 are symmetrical about an axis of 45°, and Sis a length of the straight waveguide. In this case, optical paths of the straight waveguide A1 and the straight waveguide B4 are respectively:

$${L}_{1} = ( {n}_{x} {cos}^{2} ( θ + {n}_{y} {sin}^{2} θ ) \times S$$

$${L}_{4} = ( {n}_{x} * {cos}^{2} ( 90 ° - θ ) + {n}_{y} {sin}^{2} ( 90 ° - θ ) ) \times S$$

A sum of the two is as follows:

$${L}_{1} + {L}_{4} = ( {n}_{x} + {n}_{y} ) \times S$$

It can be seen that an optical path obtained after addition is not related to a straight waveguide path, and is only related to a length.

Similarly, the optical paths of the bent waveguides 2 and 3 are calculated by means of integration as follows:

$${L}_{2} = ( {n}_{x} ( - \frac{cos 2 θ}{4} + \frac{θ}{2} + \frac{1}{4} ) + {n}_{y} ( \frac{cos 2 θ}{4} + \frac{θ}{2} - \frac{1}{4} ) ) \times R$$

$${L}_{3} = ( {n}_{x} ( \frac{cos 2 θ}{4} + \frac{θ}{2} - \frac{1}{4} ) + {n}_{y} ( - \frac{cos 2 θ}{4} + \frac{θ}{2} + \frac{1}{4} ) ) \times R$$

R is a waveguide bending radius, and θ is a waveguide bending angle. A sum of the two is as follows:

$${L}_{2} + {L}_{3} = ( {n}_{x} + {n}_{y} ) \times R θ$$

It can be seen that an optical path obtained after addition is not related to a bent waveguide path, and is only related to a bent waveguide radius and a bending angle.

The foregoing conclusion may be generalized to structures such as a slab waveguide and a tapered waveguide. That is, when the waveguide structure is symmetrical along an axis of 45° or 135°, regardless of a path of each waveguide, an optical path difference between adjacent arrayed waveguides can be kept constant as long as it is ensured that a total length difference of waveguide paths is constant. This design method skillfully avoids the impact of birefringence, and converts an anisotropic device design into an isotropic design.

When it is ensured that an optical path difference between adjacent arrayed waveguides is constant ΔL, an interference principal maximum may be formed for light of a certain wavelength at a position of a corresponding output waveguide:

$$I = {I}_{0} + {I}_{1} {e}^{j Δ L} + {I}_{2} {e}^{j 2 Δ L} + … + {I}_{n} {e}^{j n Δ L}$$

If the energy in the arrayed waveguides is equal (only for example), the interference principal maximum may be obtained by the following expression:

$$I = {I}_{0} \frac{sin ( N Δ L / 2 )}{sin ( Δ L / 2 )}$$

Output waveguides are placed at different positions on an image surface to obtain light of different wavelengths, thereby implementing a wavelength division multiplexing function.

### Embodiment 2

This embodiment of the disclosure provides a design of a wavelength division multiplexer structure based on a cascaded MZI of X-cut thin film lithium niobate. As shown in FIG. 3 and FIG. 4, the device sequentially includes an upper arm 12 and a lower arm 13 of the single-level MZI in FIG. 3, an input waveguide 14, a 3 dB directional coupler 15, and an output waveguide 16. A cross section of the foregoing waveguide structure is shown in FIG. 4, and includes a thin film lithium niobate waveguide layer 19, a silicon dioxide upper clad layer 17, and a buried oxide layer 19.

As shown in FIG. 1, when the waveguide path is symmetrical along an axis of 45° or 135°, a waveguide optical path is not related to a waveguide path, and is only related to a waveguide length and an equivalent refractive index. Based on this conclusion, each group of phase control waveguides in the cascaded MZI provided in Embodiment 2 are symmetrical along an axis of 135°, and a length of the phase control waveguide is designed according to a designed optical path difference. Compared with a conventional MZI structure, in this case, the phase control waveguide may be designed according to any path, which can make the structure more efficient and compact to some extent.

The light is divided into two beams of coherent light of equal intensity by the 3 dB directional coupler in FIG. 4. The two paths of light have a difference of π/2. After passing through the phase control waveguide, the lower arm 13 lags behind the upper arm 12 by βΔL. After passing through the second 3 dB directional coupler, the lower arm 13 lags behind the upper arm by π/2. According to the principle of interference enhancement, the wavelengths of output optical signals of the upper arm 12 and the lower arm 13 respectively satisfy:

$$βΔ L = 2 k π$$

$$βΔ L = ( 2 k + 1 ) π$$

Therefore, based on the single-level MZI structure, beam splitting of different wavelengths may be simply implemented.

However, a pass-band characteristic of a single-level MZI filter is of a sine type, and an effective bandwidth is excessively narrow and cannot satisfy requirements in actual applications. To implement flat-top spectrum distribution of a device, in actual applications, a cascaded MZI structure is generally used. In addition, to multiplex and demultiplex optical signals of more wavelengths, a binary tree structure may be introduced. As shown in FIG. 3, multiplexing and demultiplexing of 4 channels may be implemented.

The foregoing descriptions are not intended to limit the disclosure. It is to be noted that a person of ordinary skill in the art may make various changes, modifications, additions, or replacements without departing from the substantive scope of the disclosure. These improvements and modifications shall fall within the protection scope of the disclosure.

What is claimed is:

1. A phase control waveguide structure based on an anisotropic material, wherein the phase control waveguide structure comprises two-side waveguide units that are symmetrically arranged, the waveguide unit comprises a straight waveguide and a bent waveguide that are connected, the phase control waveguide structure comprises a straight waveguide A, a bent waveguide A, a bent waveguide B, and a straight waveguide B that are sequentially connected, and the straight waveguide A, the bent waveguide A, the bent waveguide B, and the straight waveguide B are symmetrically arranged along an axis that forms an included angle of 45° or 135° with both crystal axes of a surface of the anisotropic material.

2. The phase control waveguide structure according to claim 1, wherein a length of the straight waveguide A is equal to that of the straight waveguide B, and a bending radius and a bending angle of the bent waveguide A are equal to those of the bent waveguide B.

3. The phase control waveguide structure according to claim 1, wherein a cross section of the phase control waveguide structure comprises a buried oxide layer, a waveguide layer, and a silicon dioxide upper clad layer from bottom to top, and the anisotropic material is X-cut thin film lithium niobate.

4. The phase control waveguide structure according to claim 3, wherein a radius of the bent waveguide is equal to or greater than 50 microns, and the waveguide layer is a ridge waveguide or a strip waveguide.

5. A wavelength division multiplexer structure based on an arrayed waveguide grating, based on an anisotropic material and comprising a phase control waveguide structure, wherein the structure comprises an input waveguide, an input end free propagation region, an input end tapered waveguide, an arrayed waveguide, an output end tapered waveguide, an output end free propagation region, and an output waveguide that are sequentially connected.

6. The wavelength division multiplexer structure based on an arrayed waveguide grating and comprising a phase control waveguide structure according to claim 5, wherein the input end free propagation region and the output end free propagation region, the input end tapered waveguide and the output end tapered waveguide, and the arrayed waveguide itself are symmetrically arranged about an axis that forms an included angle of 45° or 135° with both crystal axes of a surface of the anisotropic material.

7. The wavelength division multiplexer structure based on an arrayed waveguide grating and comprising a phase control waveguide structure according to claim 5, wherein the input end tapered waveguide and the output end tapered waveguide are configured to reduce a coupling loss between modes, and the input waveguide and the output waveguide are respectively configured for input and output of optical signals.

8. A wavelength division multiplexer structure based on a cascaded Mach-Zehnder interferometer, based on an anisotropic material and comprising a phase control waveguide structure, wherein the structure is a binary tree structure comprising single-level MZI units connected by a 3 dB directional coupler, the single-level MZI unit comprises an upper arm and a lower arm of the phase control waveguide structure, and the upper arm and the lower arm are symmetrically arranged about an axis that forms an included angle of 45° or 135° with both crystal axes of a surface of the anisotropic material.

9. The wavelength division multiplexer structure based on a cascaded Mach-Zehnder interferometer and comprising a phase control waveguide structure according to claim 8, wherein the structure comprises an input waveguide, single-level MZI units, a 3 dB directional coupler connected to each single-level MZI unit and configured for beam combining and beam splitting, and an output waveguide.

10. The wavelength division multiplexer structure based on a cascaded Mach-Zehnder interferometer and comprising a phase control waveguide structure according to claim 8, wherein each single-level MZI unit comprises two interference arms, that is, an upper arm and a lower arm, formed after beam splitting, and the upper arm and the lower arm have a length difference.

11. The phase control waveguide structure according to claim 2, wherein a cross section of the phase control waveguide structure comprises a buried oxide layer, a waveguide layer, and a silicon dioxide upper clad layer from bottom to top, and the anisotropic material is X-cut thin film lithium niobate.

12. The phase control waveguide structure according to claim 11, wherein a radius of the bent waveguide is equal to or greater than 50 microns, and the waveguide layer is a ridge waveguide or a strip waveguide.
